(19) United States
(12) Patent Application Publication
(10) Pub. No.: US 2026/0346234 A1
(43) Pub. Date: Nov. 5, 2026

(54) CATALYST COMPOSITION, AMMONIA SYNTHESIS METHOD, AMMONIA DECOMPOSITION METHOD, AND METHOD FOR PRODUCING PEROVSKITE-TYPE OXYHYDRIDE

(71) Applicant: JAPAN SCIENCE AND TECHNOLOGY AGENCY, Kawaguchi-shi, Saitama (JP)

(72) Inventors: Hideo HOSONO, Yamato-shi (JP); Masaaki KITANO, Machida-shi (JP); Satoru MATSUISHI, Hachioji-shi (JP); Toshiharu YOKOYAMA, Yokohama-shi (JP); Masayoshi MIYAZAKI, Toyonaka-shi (JP); Shun SATO, Takasaki-shi (JP)

(73) Assignee: JAPAN SCIENCE AND TECHNOLOGY AGENCY, Kawaguchi-shi, Saitama (JP)

(21) Appl. No.: 19/486,231

(22) PCT Filed: Mar. 21, 2024
(86) PCT No.: PCT/JP2024/011019

§ 371 Date: Nov. 20, 2025

(30) Foreign Application Priority Data
May 26, 2023 (JP) 2023-086677

(51) Int. Cl. B01J 23/10; B01J 23/46; B01J 35/61; B01J 35/70; B01J 37/00; B01J 37/08; C01B 3/047; C01C 1/04

(52) U.S. Cl. CPC B01J 23/10; B01J 23/462; B01J 35/612; B01J 35/733; B01J 37/0027; B01J 37/08; C01B 3/047; C01C 1/0411; C01B 2203/0277

(57) ABSTRACT

A catalyst composition is provided that exhibits sufficient activity even under low-temperature and low-pressure conditions. The composition contains a perovskite-type oxyhydride represented by formula (1) in the specification.

### CROSS-REFERENCE TO RELATED APPLICATIONS

This application is a Section 371 of International Application No. PCT/JP2024/011019, filed Mar. 21, 2024, which published in the Japanese language as WO 2024/247448 A1 on Dec. 5, 2024, and which claims priority under 35 U.S.C. § 119(b) to Japanese Patent Application No. JP 2023-086677, filed on May 26, 2023, the disclosures of which are incorporated herein by reference in their entireties.

### TECHNICAL FIELD

The present invention relates to a catalyst composition, an ammonia synthesis method, an ammonia decomposition method, and a method for producing a perovskite-type oxyhydride.

### BACKGROUND ART

Ammonia is an important compound as a raw material for various chemical products. For example, the Haber-Bosch process, a representative ammonia synthesis method, uses a doubly promoted iron catalyst containing Fe₃O₄ and several mass % of Al₂O₃ and K₂O, and directly reacts the mixed gas of nitrogen and hydrogen in the presence of this catalyst under high temperature and high pressure conditions to produce ammonia. This technology is still used industrially today in a process substantially unchanged since its development.

On the other hand, methods for synthesizing ammonia at temperatures lower than the reaction temperature of the Haber-Bosch process have been studied. Catalysts capable of synthesizing ammonia by contacting nitrogen and hydrogen, such as those with transition metals as catalytically active components, have been investigated. Among these, a method of using ruthenium (Ru) supported on various supports as a catalyst for ammonia synthesis reactions has been proposed as an efficient method (for example, Patent Document 1).

### CITATION LIST

### Patent Documents

Patent Document 1: Japanese Patent Application Laid-Open No. 2006-231229

### SUMMARY OF THE INVENTION

### Technical Problem

Ammonia synthesis by the Haber-Bosch process, which mainly uses a doubly promoted iron catalyst, has been put to practical use, but the process requires high temperature and high pressure conditions, which pose problems in terms of equipment and costs.

Supported metal catalysts, such as those described in Patent Document 1, generally use a carbonaceous support such as activated carbon or an inorganic oxide support. However, these supported metal catalysts do not always have sufficient performance for practical use.

In other words, there is a demand for ammonia synthesis catalysts with superior catalytic activity, for example, those having sufficient reaction activity even under lower temperature and lower pressure conditions compared to the reaction conditions of the Haber-Bosch process.

The present invention has been made in consideration of the above circumstances, and aims to provide a catalyst composition that has sufficient reaction activity even under low-temperature and low-pressure conditions, an ammonia synthesis method, an ammonia decomposition method, and a method for producing a perovskite-type oxyhydrides.

### Solution to Problem

To solve the above problem, the present invention proposes the following aspects.

<1> A catalyst composition of aspect 1 of the present invention contains a perovskite-type oxyhydride represented by the following formula (1):

BaREO₂Hₘ (1)

(In formula (1), RE represents a rare earth element selected from the group consisting of Y, Sc, Gd, Tb, Dy, Ho, Er, Tm, Yb, and Lu, and m represents a value in the range of 0.5 to 1.0.)

<2> Aspect 2 of the present invention is the catalyst composition according to aspect 1, wherein RE may be a rare earth element selected from the group consisting of Y, Sc, Tb, Dy, Ho, Er, Yb, and Lu.

<3> Aspect 3 of the present invention is the catalyst composition according to aspect 1, wherein RE may be Y or Sc.

<4> Aspect 4 of the present invention is the catalyst composition according to aspect 1, which may be for an ammonia synthesis reaction or an ammonia decomposition reaction.

<5> Aspect 5 of the present invention is the catalyst composition according to any one of aspects 1 to 4, wherein the perovskite-type oxyhydride may support one or more transition metals selected from the group consisting of Ru, Co, Fe, Cr, and Mn.

<6> An ammonia synthesis method of aspect 6 of the present invention comprises a step of reacting nitrogen with hydrogen in the presence of the catalyst composition according to any one of aspects 1 to 5.

<7> An ammonia decomposition method of aspect 7 of the present invention comprises a step of decomposing ammonia into hydrogen and nitrogen in the presence of the catalyst composition according to any one of aspects 1 to 5.

<8> A method for producing a perovskite-type oxyhydride of aspect 8 of the present invention is a method for producing a perovskite-type oxyhydride represented by the following formula (1):

BaREO₂Hₘ (1)

(In formula (1), RE represents a rare earth element selected from the group consisting of Y, Sc, Gd, Tb, Dy, Ho, Er, Tm, Yb, and Lu, and m represents a value in the range of 0.5 to 1.0.)
the method comprising a step of repeatedly performing crimping and pulverization under an inert gas atmosphere using a mechanochemical method on BaO, BaH₂, and a compound represented by the following formula (2):

RE₂O₃ (2)

(In formula (2), RE represents a rare earth element selected from the group consisting of Y, Sc, Gd, Tb, Dy, Ho, Er, Tm, Yb, and Lu.)
until refined and homogeneous particles of a synthesis reaction product are formed.

<9> Aspect 9 of the present invention is the method for producing a perovskite-type oxyhydride according to aspect 8, wherein RE may be a rare earth element selected from the group consisting of Y, Sc, Tb, Dy, Ho, Er, Yb, and Lu.

<10> Aspect 10 of the present invention is the method for producing a perovskite-type oxyhydride according to aspect 8, wherein RE may be Y or Sc.

<11> Aspect 11 of the present invention is the method for producing a perovskite-type oxyhydride according to aspect 8, wherein RE may be Y.

<12> Aspect 12 of the present invention is the method for producing a perovskite-type oxyhydride according to aspect 8, wherein a planetary ball mill or a tumbling ball mill may be used in the mechanochemical method.

<13> Aspect 13 of the present invention is the method for producing a perovskite-type oxyhydride according to aspect 8, wherein the crimping and the pulverization may be carried out at a temperature of 300 °C or less.

<14> Aspect 14 of the present invention is the method for producing a perovskite-type oxyhydride according to aspect 8, wherein the specific surface area (BET) of the refined and homogeneous particles of a synthesis reaction product may be 5.0 m²/g or less.

<15> Aspect 15 of the present invention is a perovskite-type oxyhydride which is obtained by the method for producing a perovskite-type oxyhydride according to aspect 8.

<16> Aspect 16 of the present invention is the perovskite-type oxyhydride according to aspect 15, wherein RE may be Y.

### Advantageous Effects of Invention

According to the above aspects of the present invention, it is possible to provide a catalyst composition that has sufficient reaction activity even under low-temperature and low-pressure conditions, an ammonia synthesis method, an ammonia decomposition method, and a method for producing a perovskite-type oxyhydride.

### BRIEF DESCRIPTION OF DRAWINGS

FIG. 1 is a flowchart of a method for producing a catalyst composition according to an embodiment of the present invention.

FIG. 2 shows XRD patterns of the perovskite-type oxyhydride of Example 1 (BaYO₂H, before sintering) and the perovskite-type oxyhydride of Example 2 (BaYO₂H, after sintering).

FIG. 3 shows XRD patterns of the perovskite-type oxyhydride of Example 3 (BaScO₂H, before sintering) after three reaction cycles, after four reaction cycles, and the perovskite-type oxyhydride of Example 3 (BaScO₂H, after sintering).

FIG. 4 shows TDS measurement results for the perovskite-type oxyhydride of Example 2 (BaYO₂H, after sintering) and the catalyst composition of Example 2 (i.e., Ru-supported perovskite-type oxyhydride (BaYO₂H, after sintering)).

FIG. 5 shows TDS measurement results for the perovskite-type oxyhydride of Example 3 (BaScO₂H, after sintering) and the catalyst composition of Example 3 (i.e., Ru-supported perovskite-type oxyhydride (BaScO₂H, after sintering)).

FIG. 6 shows XRD measurement results for the perovskite-type oxyhydride obtained after heat-treating the perovskite-type oxyhydride of Example 1 (BaYO₂H, before sintering) in a hydrogen atmosphere at various temperatures for 72 hours.

FIG. 7 shows time-course changes in ammonia synthesis rate for the catalyst composition of Example 2 (i.e., Ru-supported perovskite-type oxyhydride (BaYO₂H, after sintering)), the catalyst composition of Example 4 (i.e., Co-supported perovskite-type oxyhydride (BaYO₂H, after sintering)), and the catalyst composition of Example 5 (i.e., Fe-supported perovskite-type oxyhydride (BaYO₂H, after sintering)) when exposed to a mixed gas flow of H₂ and N₂ at 0.9 MPa and 300 °C.

FIG. 8 shows pressure dependence of ammonia synthesis rate for the catalyst composition of Example 2 (i.e., Ru-supported perovskite-type oxyhydride (BaYO₂H, after sintering)), the catalyst composition of Example 4 (i.e., Co-supported perovskite-type oxyhydride (BaYO₂H, after sintering)), and the catalyst composition of Example 5 (i.e., Fe-supported perovskite-type oxyhydride (BaYO₂H, after sintering)) when exposed to a mixed gas flow of H₂ and N₂ at 320 °C.

FIG. 9 shows temperature dependence of ammonia synthesis rate for the catalyst composition of Example 2 (i.e., Ru-supported perovskite-type oxyhydride (BaYO₂H, after sintering)), the catalyst composition of Example 4 (i.e., Co-supported perovskite-type oxyhydride (BaYO₂H, after sintering)), and the catalyst composition of Example 5 (i.e., Fe-supported perovskite-type oxyhydride (BaYO₂H, after sintering)) when exposed to a mixed gas flow of H₂ and N₂ at 0.9 MPa.

FIG. 10 shows time-course changes in ammonia synthesis rate for the catalyst composition of Example 1 (i.e., Ru-supported perovskite-type oxyhydride (BaYO₂H, before sintering)) and the catalyst composition of Example 2 (i.e., Ru-supported perovskite-type oxyhydride (BaYO₂H, after sintering)) when exposed to a mixed gas flow of H₂ and N₂ at 0.9 MPa and 300 °C.

FIG. 11 shows time-course changes in ammonia synthesis rate for the catalyst composition of Example 2 (i.e., Ru-supported perovskite-type oxyhydride (BaYO₂H, after sintering)) and the catalyst composition of Example 3 (i.e., Ru-supported perovskite-type oxyhydride (BaScO₂H, after sintering)).

FIG. 12 shows ammonia synthesis rate for the catalyst compositions of Example 2 (i.e., Ru-supported perovskite-type oxyhydride (BaYO₂H, after sintering)), Example 4 (i.e., Co-supported perovskite-type oxyhydride (BaYO₂H, after sintering)), Example 5 (i.e., Fe-supported perovskite-type oxyhydride (BaYO₂H, after sintering)), and Comparative Examples 1-8 when exposed to a mixed gas flow of H₂ and N₂ at 0.9 MPa and 300 °C.

FIG. 13 shows temperature dependence of ammonia conversion for the catalyst composition of Example 2 (i.e., Ru-supported perovskite-type oxyhydride (BaYO₂H, after sintering)) and the catalyst composition of Comparative Example 9 when exposed to ammonia at 0.1 MPa.

FIG. 14 shows XRD patterns of the perovskite-type oxyhydrides of Example 7 (BaTbO₂H, BaDyO₂H, BaHoO₂H, BaErO₂H, BaYbO₂H, BaLuO₂H, after sintering).

FIG. 15 shows TDS measurement results for the perovskite-type oxyhydrides of Example 7 (BaTbO₂H, BaDyO₂H, BaHoO₂H, BaErO₂H, BaYbO₂H, BaLuO₂H, after sintering).

FIG. 16 shows TDS measurement results for the catalyst composition of Example 8 (i.e., Ru-supported perovskite-type oxyhydride (BaTbO₂H, BaDyO₂H, BaHoO₂H, BaErO₂H, BaYbO₂H, BaLuO₂H, after sintering)).

FIG. 17 shows time-course changes in ammonia synthesis rate for the catalyst composition of Example 2 (i.e., Ru-supported perovskite-type oxyhydride (BaYO₂H, after sintering)), the catalyst composition of Example 3 (i.e., Ru-supported perovskite-type oxyhydride (BaScO₂H, after sintering)), and the catalyst composition of Example 8 (i.e., Ru-supported perovskite-type oxyhydride (BaTbO₂H, BaDyO₂H, BaHoO₂H, BaErO₂H, BaYbO₂H, BaLuO₂H, after sintering)) when exposed to a mixed gas flow of H₂ and N₂ at 0.9 MPa and 300 °C.

FIG. 18 shows ammonia synthesis rate for the catalyst composition of Example 2 (i.e., Ru-supported perovskite-type oxyhydride (BaYO₂H, after sintering)), the catalyst composition of Example 3 (i.e., Ru-supported perovskite-type oxyhydride (BaScO₂H, after sintering)), and the catalyst composition of Example 8 (i.e., Ru-supported perovskite-type oxyhydride (BaTbO₂H, BaDyO₂H, BaHoO₂H, BaErO₂H, BaYbO₂H, BaLuO₂H, after sintering)) when exposed to a mixed gas flow of H₂ and N₂ at 0.9 MPa and 300 °C.

### DESCRIPTION OF EMBODIMENTS

Hereinafter, a catalyst composition, an ammonia synthesis method, an ammonia decomposition method, and a method for producing a perovskite-type oxyhydride according to an embodiment of the present invention will be described.

### (Catalyst Composition)

The catalyst composition according to the present embodiment contains a perovskite-type oxyhydride. Here, the perovskite-type oxyhydride refers to a substance in which a portion of the oxygen anions O²⁻ in a perovskite-type oxide ABO₃ is replaced with hydrogen anions H⁻. The catalyst composition according to the present embodiment is preferably for an ammonia synthesis reaction or an ammonia decomposition reaction.

### “Perovskite-Type Oxyhydride”

The perovskite-type oxyhydride according to the present embodiment is represented by the following formula (1). In the following formula (1), RE represents a rare earth element selected from the group consisting of Y, Sc, Gd, Tb, Dy, Ho, Er, Tm, Yb, and Lu, and m represents a value in the range of 0.5 to 1.0. The catalyst composition according to the present embodiment containing the perovskite-type oxyhydride represented by the following formula (1) enables relatively easy formation of hydrogen vacancies on the surface of the catalyst. This can further improve the catalytic performance of the catalyst composition.

BaREO₂Hₘ (1)

The catalyst composition according to the embodiment of the present invention includes, for example, BaYO₂Hₘ₁ (0.5≤m1≤1.0), BaScO₂Hₘ₂ (0.5≤m2≤1.0), BaGdO₂Hₘ₃ (0.5≤m3≤1.0), BaTbO₂Hₘ₄ (0.5≤m4≤1.0), BaDyO₂Hₘ₅ (0.5≤m5≤1.0), BaHoO₂Hₘ₆ (0.5≤m6≤1.0), BaErO₂Hₘ₇ (0.5≤m7≤1.0), BaYbO₂Hₘ₈ (0.5≤m8≤1.0), and BaLuO₂Hₘ₉ (0.5≤m9≤1.0).

In the catalyst composition according to the present embodiment, it is preferable that RE in the above formula (1) is at least one rare earth element selected from the group consisting of Y, Sc, Tb, Dy, Ho, Er, Yb, and Lu, and it is more preferable that RE is Y or Sc. By having RE as Y or Sc, the catalytic performance can be further improved. Examples of the catalyst composition according to the present embodiment in which RE is Y or Sc include BaYO₂Hₘ₁ (0.5≤m1≤1.0) and BaScO₂Hₘ₂ (0.5≤m2≤1.0). As the catalyst composition according to the present embodiment, BaYO₂H and BaScO₂H are preferable. BaYO₂H is less expensive in terms of raw material costs compared to BaScO₂H and exhibits higher stability when used for long-term ammonia synthesis. Therefore, BaYO₂H is even more preferable as the catalyst composition according to the present embodiment.

The characterization of the perovskite-type oxyhydride according to the present embodiment may be performed using methods, which are commonly used in the technical field, either alone or in combination. For example, Rietveld analysis of X-ray diffraction (XRD) patterns, Thermal Desorption Spectroscopy (TDS) measurement, Fourier Transform Infrared (FT-IR) Spectroscopy measurement, nitrogen adsorption measurement, and the like may be conducted.

The perovskite-type oxyhydride according to the present embodiment forms a cubic crystal. The cubic perovskite structure is the most densely packed structure among perovskite structures based on close packing and is easily stabilized in synthesis methods that generate high pressure, such as a mechanochemical method. Confirmation that the perovskite-type oxyhydride is cubic can be performed by measuring with X-ray diffraction (XRD) and conducting Rietveld analysis on the obtained XRD pattern.

The shape of the perovskite-type oxyhydride according to the present embodiment is preferably particulate. The particle size of the perovskite-type oxyhydride according to the present embodiment is preferably 1 nm or more and 10 μm or less. More preferably, the particle size of the perovskite-type oxyhydride is 1 nm or more and 1 μm or less, still more preferably 1 nm or more and 100 nm or less, and particularly preferably 1 nm or more and 50 nm or less.

It should be noted that the cation composition ratio in the perovskite-type oxyhydride can be measured, for example, using an electron probe micro analyzer (EPMA).

The specific surface area (BET specific surface area) of the perovskite-type oxyhydride according to the present embodiment is preferably 5.0 m²/g or less. The specific surface area of the perovskite-type oxyhydride according to the present embodiment may be 1.0 m²/g or more. The specific surface area of the perovskite-type oxyhydride according to the present embodiment is preferably 2.0 m²/g or more.

### Supported Metal

In the catalyst composition, it is preferable that the perovskite-type oxyhydride supports a metal (sometimes referred to as a supported metal). The supported metal has catalytic activity. The supported metal is not particularly limited as long as it promotes an ammonia synthesis reaction or an ammonia decomposition reaction. Examples of the supported metal include Ru, Co, Fe, Ni, Mo, Rh, Re, Cr, and Mn. It is preferable that the perovskite-type oxyhydride according to the present embodiment supports one or more transition metals selected from the group consisting of Ru, Co, Fe, Cr, and Mn (hereinafter sometimes referred to as supported transition metals). It is more preferable that the perovskite-type oxyhydride according to the present embodiment supports Ru. By the perovskite-type oxyhydride according to the present embodiment supporting one or more transition metals selected from the group consisting of Ru, Co, Fe, Cr, and Mn, hydrogen diffusion and reversible hydrogen exchange on the surface of the perovskite-type oxyhydride are further promoted, which is preferable because it further enhances catalytic performance.

Each element of the supported metal may be used alone or in combination of two or more. Additionally, compounds of these elements, such as Co₃Mo₃N, Fe₃Mo₃N, Ni₂Mo₃N, Mo₂N, etc., may be used as the supported metal.

The loading of the supported transition metal relative to the perovskite-type oxyhydride according to the present embodiment is preferably 1 wt % or more and 10 wt % or less relative to the total mass of the catalyst composition. More preferably, the loading of the supported transition metal is 1 wt % or more and 8 wt % or less relative to the total mass of the catalyst composition. Even more preferably, it is 3 wt % or more and 5 wt % or less.

### (Method for Producing Catalyst Composition)

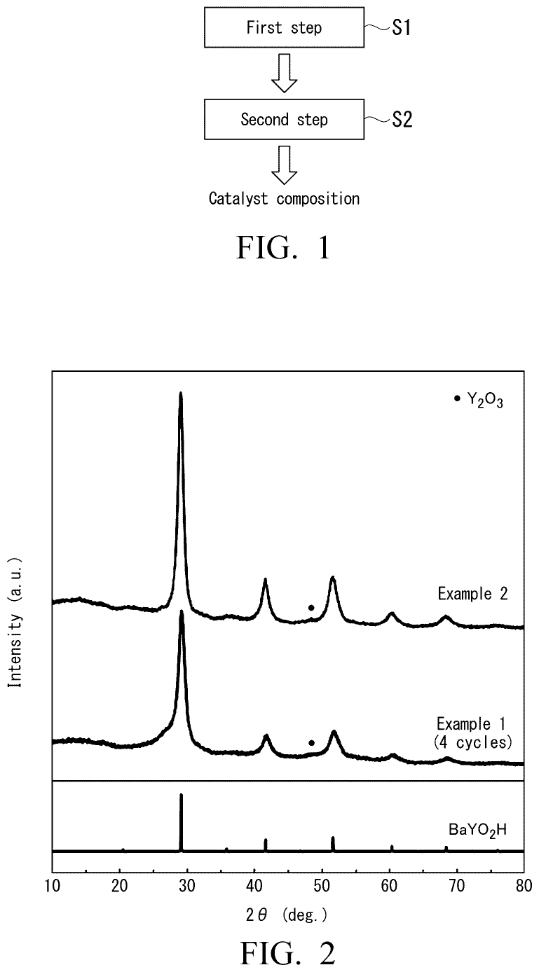

Next, the method for producing the catalyst composition according to the present embodiment will be described. FIG. 1 is a flowchart of the method for producing the catalyst composition according to an embodiment of the present invention. As shown in FIG. 1, the method for producing the catalyst composition includes a first step S1 of producing a perovskite-type oxyhydride as a support and a second step S2 of supporting a transition metal on the perovskite-type oxyhydride produced in the first step S1.

### First Step

First, the method for producing the perovskite-type oxyhydride, which is the first step S1, will be described. The method for producing the perovskite-type oxyhydride represented by the following formula (1) includes a step of repeatedly performing crimping and pulverization under an inert gas atmosphere using a mechanochemical method on BaO, BaH₂, and a compound represented by the following formula (2) until refined and homogeneous particles of a synthesis reaction product are formed. The refined and homogeneous particles of a synthesis reaction product formed are the perovskite-type oxyhydride.

### Raw Materials

In the first step S1, BaO, BaH₂, and a compound represented by the following formula (2) are used as raw materials. In the following formula (1), RE represents a rare earth element selected from the group consisting of Y, Sc, Gd, Tb, Dy, Ho, Er, Tm, Yb, and Lu, and m represents a value in the range of 0.5 to 1.0. In the following formula (2), RE represents a rare earth element selected from the group consisting of Y, Sc, Gd, Tb, Dy, Ho, Er, Tm, Yb, and Lu. In formula (2), RE is preferably Y or Sc.

BaREO₂Hₘ (1)

RE₂O₃ (2)

Examples of the compound represented by the above formula (2) include Y₂O₃, Sc₂O₃, Gd₂O₃, Tb₂O₃, Dy₂O₃, H₀₂₀₃, Er₂O₃, Tm₂O₃, Yb₂O₃, and Lu₂O₃. As the compound represented by the above formula (2), Y₂O₃ or Sc₂O₃ is preferable. As the compound represented by the above formula (2), Y₂O₃ is even more preferable.

The molar ratio of the raw materials BaO, BaH₂, and the compound represented by the above formula (2) (hereinafter sometimes referred to as the charging molar ratio) (BaO:BaH₂:compound represented by the above formula (2)) is, for example, 1.0:0.90-1.10:0.90-1.10. More preferably, the charging molar ratio of BaO, BaH₂, and the compound represented by the above formula (2) is 1.0:1.0:1.0.

The raw materials for the synthesis reaction used to form the particles of the synthesis reaction product by the mechanochemical method may be obtained by adding them at the above charging molar ratio or may be obtained by preliminarily mixing them at the above charging molar ratio.

### Crimping and Pulverization

The above raw materials are repeatedly subjected to crimping and pulverization under an inert gas atmosphere using a mechanochemical method until refined and homogeneous particles of a synthesis reaction product are formed. The mechanochemical method refers to a method that causes chemical changes with surrounding substances by applying mechanical energy. By applying mechanical energy (e.g., causing balls to collide), the raw materials are compacted (pressed together). Furthermore, when the balls collide, the compacted material is pulverized. By repeating this crimping and pulverization, the raw materials react while being refined and homogeneous, forming particles of the synthesis reaction product.

In the mechanochemical method, it is preferable to use a planetary ball mill or a tumbling ball mill. By using a planetary ball mill or a tumbling ball mill, the crimping and pulverization of the raw materials can be performed efficiently. The material of the balls and the container used in the ball mill are not particularly limited, but examples include ZrO₂ and WC. The diameter of the balls used in the ball mill is, for example, 10 mm to 20 mm.

The rotation speed of the ball mill is not particularly limited as long as it can produce refined and homogeneous particles of a synthesis reaction product, and is, for example, 600 rpm to 900 rpm.

It is preferable to alternately repeat a circle of the step of crimping and pulverization (hereinafter sometimes referred to as mechanochemical reaction) and a step of cooling until refined and homogeneous particles of a synthesis reaction product are formed. By alternately performing the step of the mechanochemical reaction and the step of cooling, refined and homogeneous particles of a synthesis reaction product can be formed more efficiently. After cooling, the reacted product lump may be ground into a powder using a mortar or the like.

The processing time per cycle of crimping and pulverization (reaction time of the mechanochemical reaction) is not particularly limited, but is, for example, 1 min to 10 min. In this mechanochemical reaction, the crimping and pulverization of the raw materials are repeatedly performed.

The crimping and pulverization are preferably performed at 300 °C or less. By performing the mechanochemical reaction at 300 °C or less, hydrogen desorption can be suppressed.

Cooling to room temperature after the mechanochemical reaction is preferable. The cooling method is not particularly limited, but for example, cooling may be performed by allowing heat to dissipate after the mechanochemical reaction is completed.

Whether refined and homogeneous particles of a synthesis reaction product have been formed can be confirmed by the following method. First, X-ray diffraction (XRD) measurement of the sample is performed. If no diffraction lines derived from the raw materials are observed in the obtained XRD pattern, it is determined that a homogeneous synthesis reaction product has been formed. Additionally, if no change is observed in the XRD pattern, it is similarly determined that a homogeneous synthesis reaction product has been formed.

Next, scanning electron microscope (SEM) observation is performed on the sample confirmed to be a homogeneous synthesis reaction product. If particles of the perovskite-type oxyhydride with a particle size of 10 μm or less can be confirmed by SEM observation, it is determined that refined and homogeneous particles of a synthesis reaction product have been formed. The determination of the particles of the perovskite-type oxyhydride can be performed using EDX (energy-dispersive X-ray spectroscopy) attached to the SEM.

Of course, the confirmation of refinement and homogenization may be performed in the reverse order, i.e., first confirming the formation of a refined synthesis reaction product and then, regarding the refined synthesis reaction product, confirming the formation of refined and homogeneous particles of a synthesis reaction product.

In the first step, the refined and homogeneous particles of a synthesis reaction product may be further sintered. Sintering can promote crystallization. The sintering temperature is preferably 450 °C or more and less than 600 °C. A more preferable sintering temperature is 500 °C or more and 550 °C or less. The sintering time is not particularly limited but is 1 hour (1 h) or more. The sintering time may be, for example, 72 hours or less. The sintering process is preferably performed under a vacuum atmosphere or a hydrogen atmosphere. Preferably, it is performed under a vacuum atmosphere (e.g., a vacuum level of about 10⁻³ Pa or less) because surface modification such as hydration is minimal. The vacuum atmosphere may be formed, for example, using a turbo molecular pump.

Before sintering, the particles of the synthesis reaction product may be washed with NH₄Cl/MeOH (concentration, for example, 0.1 mol/L) to remove residual BaH₂ and BaO.

### (Ammonia Synthesis Method)

Next, the ammonia synthesis method will be described. The ammonia synthesis method according to the present embodiment includes a step of reacting hydrogen (H₂) and nitrogen (N₂) in the presence of the catalyst composition according to the present embodiment. Ammonia can be obtained by reacting hydrogen (H₂) and nitrogen (N₂).

The method of reacting nitrogen and hydrogen in the presence of the catalyst composition according to the present embodiment is not particularly limited. For example, hydrogen and nitrogen may be flowed into a container filled with the catalyst to react nitrogen and hydrogen.

The method for preparing the mixed gas is not particularly limited. For example, hydrogen (H₂) and nitrogen (N₂) may be flowed separately into the container, or a mixed gas with a predetermined ratio may be flowed into the container. The molar ratio of hydrogen (H₂) to nitrogen (N₂) flowing into the container is preferably 3:1.

The pressure inside the container during ammonia synthesis is not particularly limited but is, for example, 0.1 MPa to 0.9 MPa. Higher pressure is preferable as it promotes the reaction.

The reaction temperature during ammonia synthesis is preferably 300 °C or more. The higher the reaction temperature, the higher the ammonia synthesis rate, but at 600 °C or more, the catalyst may decompose. Therefore, the temperature during ammonia synthesis is preferably less than 600 °C. A more preferable reaction temperature is 550 °C or less. The reaction temperature is the temperature inside the reaction system and may be considered the same as the surface temperature of the catalyst.

### (Ammonia Decomposition Method)

Next, the ammonia decomposition method according to the present embodiment will be described. The ammonia decomposition method according to the present embodiment includes a step of decomposing ammonia into hydrogen and nitrogen in the presence of the catalyst composition according to the present embodiment.

The method of decomposing ammonia into hydrogen and nitrogen in the presence of the catalyst composition according to the present embodiment is not particularly limited. For example, ammonia may be flowed into a container filled with the catalyst to decompose it into nitrogen and hydrogen.

The pressure inside the container during ammonia decomposition is not particularly limited but is, for example, 0.1 MPa to 0.9 MPa. Higher pressure is preferable as it promotes the reaction.

The reaction temperature during ammonia decomposition is preferably 300 °C or more. The higher the reaction temperature, the higher the ammonia decomposition rate, but at 600 °C or more, the catalyst may decompose. Therefore, the temperature during ammonia decomposition is preferably less than 600 °C. A more preferable reaction temperature is 550 °C or less. The reaction temperature is the temperature inside the reaction system and may be considered the same as the surface temperature of the catalyst.

The catalyst composition, ammonia synthesis method, ammonia decomposition method, and method for producing a perovskite-type oxyhydride according to the present embodiment have been described above. The catalyst composition according to the present embodiment has sufficient reaction activity even under low-temperature and low-pressure conditions. Additionally, by using the catalyst composition according to the present embodiment, ammonia synthesis and ammonia decomposition can be performed even under low-temperature and low-pressure conditions.

The technical scope of the present invention is not limited to the above embodiment, and various modifications can be made without departing from the spirit of the present invention. In addition, it is possible to appropriately replace the constituent elements in the above embodiment with well-known constituent elements within the scope not departing from the spirit of the present invention, and the above-described modifications may be appropriately combined.

### EXAMPLES

### (BaH₂)

BaH₂ was synthesized by heating Ba (dendritic pieces, 99.99%, Aldrich) in hydrogen at 600 °C for 12 hours.

### Example 1

Production of Perovskite-Type Oxyhydride (BaYO₂H, Before Sintering) and Ru-Supported Perovskite-Type Oxyhydride (BaYO₂H, Before Sintering)

All operations of the mechanochemical method were performed in a glovebox filled with Ar. A planetary ball mill (Pulverisette 7 Premium Line, Fritsch) was used as the apparatus for performing the mechanochemical method. A container (Fritsch) made of WC with a capacity of 20 mL was used as the pulverization container, and pulverization was performed using 10 balls, with a diameter of 10 mm, made of the same material as the container. BaO (99.99%, Aldrich), BaH₂, and Y₂O₃ (>99.9%, Kojundo Chemical Laboratory Co., Ltd.) were weighed to a total amount of approximately 2 g at a charging molar ratio (1:1:1), placed in the pulverization container along with the balls, and the container was sealed with a silicon gasket by closing the container lid before being installed in the ball mill. At this time, a dummy container with matched weight was installed in the other container placement position to maintain weight balance. The revolution speed of the pulverization container was set to 800 rpm to promote the reaction to the maximum extent without contamination. A treatment consisting of 2 minutes of rotation (reaction) followed by 3 minutes of rotation stop (heat dissipation) was repeated 30 times, and this constitutes one reaction cycle of the mechanochemical method (hereinafter sometimes referred to as a reaction cycle). After one reaction cycle, the sample adhering to the container wall was scraped off and pre-ground using an agate mortar and pestle. If no diffraction lines derived from the raw materials were observed in the X-ray diffraction (XRD) pattern of the sample, or if no change was observed in the XRD pattern, it was determined that a homogeneous synthesis reaction product had been formed, and the reaction was terminated. Otherwise, the reaction cycle was repeated until the above conditions were met. Furthermore, the formation of particles of a perovskite-type oxyhydride with a particle size of 10 μm or less was confirmed by scanning electron microscope (SEM) observation of the synthesis reaction product after the mechanochemical reaction, and the product was designated as the perovskite-type oxyhydride BaYO₂H of Example 1. In the above reaction cycle, by performing the heat dissipation operation as described above, continuous temperature rise of the sample during the mechanochemical reaction was suppressed, thereby conducting the reaction under temperature conditions of 300 °C or less.

In a glovebox filled with Ar, the perovskite-type oxyhydride of Example 1 and Ru₃(CO)₁₂ (99%, Aldrich) were weighed to achieve a Ru loading of 2 wt % (42.2 mg per 1 g of the perovskite-type oxyhydride of Example 1) and mixed for about 5 minutes using a well-dried agate pestle and mortar. After mixing, the sample was filled into a quartz glass tube with one end closed and the other end attached to a balloon, and then the tube was taken out of the glovebox and vacuum-sealed. The vacuum-sealed sample was then set in an electric furnace equipped with rotary stirring and heated gradually while being stirred at 100 rpm. Specifically, the sample was held at 40 °C for 0.04 hours, heated from 40 °C to 70 °C at an average heating rate of 60 °C/h and held for 1 hour. And then heated from 70 °C to 120 °C at an average heating rate of 25 °C/h and held for 1 hour. And then heated from 120 °C to 250 °C at an average heating rate of 52 °C/h and held at 250 °C for 2 hours before being cooled to room temperature. In this manner, the catalyst composition of Example 1, i.e., Ru-supported perovskite-type oxyhydride (BaYO₂H, before sintering) with 2 wt % Ru, was obtained.

### Example 2

Production of Perovskite-Type Oxyhydride (BaYO₂H, After Sintering) and Ru-Supported Perovskite-Type Oxyhydride (BaYO₂H, After Sintering)

The perovskite-type oxyhydride of Example 1 was filled into a die with a diameter of 10 mm and subjected to uniaxial pressing at a pressure of 20-30 MPa to form pellets. After the molded sample was placed in a quartz glass tube, it was taken out of the glovebox without exposure to air, and then the tube was vacuum-sealed. After that, the tube was set in an electric furnace for heating. The temperature program for sintering involved heating at 100 °C/h to 500 °C, holding for 72 hours, and then cooling to room temperature. In this manner, the perovskite-type oxyhydride (BaYO₂H, after sintering) of Example 2 was obtained.

In a glovebox filled with Ar, the perovskite-type oxyhydride of Example 2 and Ru₃(CO)₁₂ (99%, Aldrich) were weighed to achieve a Ru loading of 2 wt % (42.2 mg per 1 g of the perovskite-type oxyhydride of Example 2) and mixed for about 5 minutes using a well-dried agate pestle and mortar. After mixing, the sample was filled into a quartz glass tube with one end closed and the other end was attached to a balloon, and then the tube was taken out of the glovebox and vacuum-sealed. The vacuum-sealed sample was then set in an electric furnace equipped with rotary stirring and heated gradually while being stirred at 100 rpm. Specifically, the sample was held at 40 °C for 0.04 hours, heated from 40 °C to 70 °C at an average heating rate of 60 °C/h and held for 1 hour. And then heated from 70 °C to 120 °C at an average heating rate of 25 °C/h and held for 1 hour. And then heated from 120 °C to 250 °C at an average heating rate of 52 °C/h and held at 250 °C for 2 hours before being cooled to room temperature. In this manner, the catalyst composition of Example 2, i.e., Ru-supported perovskite-type oxyhydride (BaYO₂H, after sintering) with 2 wt % Ru, was obtained. It should be noted that the particle size of the obtained Ru-supported perovskite-type oxyhydride, calculated by the CO chemisorption method (CO:Ru=1:1), was 8.6 nm.

### Example 3

Production of Perovskite-Type Oxyhydride (BaScO₂H, Before Sintering), Perovskite-Type Oxyhydride (BaScO₂H, After Sintering), and Ru-Supported Perovskite-Type Oxyhydride (BaScO₂H, After Sintering)

All operations of the mechanochemical method were performed in a glovebox filled with Ar. A planetary ball mill (Pulverisette 7 Premium Line, Fritsch) was used as the apparatus for performing the mechanochemical method. A container (Fritsch) made of WC with a capacity of 20 mL was used as the pulverization container, and pulverization was performed using 10 balls, with a diameter of 10 mm, made of the same material as the container. BaO (99.99%, Aldrich), BaH₂, and Sc₂O₃ (>99.9%, Kojundo Chemical Laboratory Co., Ltd.) were weighed to a total amount of approximately 2 g at a charging molar ratio (1:1:1), placed in the pulverization container along with the balls, and the container was sealed with a silicon gasket by closing the container lid before being installed in the ball mill. At this time, a dummy container with matched weight was installed in the other container placement position to maintain weight balance. The revolution speed of the pulverization container was set to 800 rpm to promote the reaction to the maximum extent without contamination. After one reaction cycle, the sample adhering to the container wall was scraped off and pre-ground using an agate mortar and pestle. In the XRD pattern of the sample after three reaction cycles of the mechanochemical method, diffraction lines derived from the target BaScO₂H were observed as the main diffraction lines. However, since diffraction lines derived from Sc₂O₃ were slightly observed, the reaction was repeated again. The XRD pattern of the sample after an additional reaction cycle showed almost no change compared to the XRD pattern before the additional reaction. Therefore, it was determined that the reaction would not proceed further, and the mechanochemical method was terminated. In this manner, the perovskite-type oxyhydride (BaScO₂H, before sintering) of Example 3 was obtained.

The perovskite-type oxyhydride of Example 3 before sintering was filled into a die with a diameter of 10 mm and subjected to uniaxial pressing at a pressure of 20-30 MPa to form pellets. After the molded sample was then placed in a quartz glass tube, it was taken out of the glovebox without exposure to air, and then the tube was vacuum-sealed. After that, the tube was set in an electric furnace for heating. The temperature program for sintering involved heating at 100 °C/h to 500 °C, holding for 72 hours, and then cooling to room temperature. In this manner, the perovskite-type oxyhydride (BaScO₂H, after sintering) of Example 3 was obtained.

In a glovebox filled with Ar, the perovskite-type oxyhydride of Example 3 after sintering and Ru₃(CO)₁₂ (99%, Aldrich) were weighed to achieve a Ru loading of 2 wt % (42.2 mg per 1 g of the perovskite-type oxyhydride of Example 3) and mixed for about 5 minutes using a well-dried agate pestle and mortar. After mixing, the sample was filled into a quartz glass tube with one end closed and the other end was attached to a balloon, and then the tube was taken out of the glovebox and vacuum-sealed. The vacuum-sealed sample was then set in an electric furnace equipped with rotary stirring and heated gradually while being stirred at 100 rpm. Specifically, the sample was held at 40 °C for 0.04 hours, heated from 40 °C to 70 °C at an average heating rate of 60 °C/h and held for 1 hour. And then heated from 70 °C to 120 °C at an average heating rate of 25 °C/h and held for 1 hour. And then heated from 120 °C to 250 °C at an average heating rate of 52 °C/h and held at 250 °C for 2 hours before being cooled to room temperature. In this manner, the catalyst composition of Example 3, i.e., Ru-supported perovskite-type oxyhydride (BaScO₂H, after sintering) with 2 wt % Ru, was obtained. It should be noted that the particle size of the obtained Ru-supported perovskite-type oxyhydride, calculated by the CO chemisorption method (CO:Ru=1:1), was 6.3 nm.

### Example 4

### Production of Co-Supported Perovskite-Type Oxyhydride (BaYO₂H, After Sintering)

In a glovebox filled with Ar, the perovskite-type oxyhydride (BaYO₂H, after sintering) of Example 2 and Co₂(CO)₈ (>95%, TCI) were weighed to achieve a Co loading of 2 wt % (59.8 mg of Co₂(CO)₈ per 1 g of BaYO₂H) and mixed for about 10 minutes using a well-dried agate pestle and mortar. After mixing, the sample was filled into a glass reaction tube after one end of the tube was closed with packed quartz wool, and both ends of the tube were sealed with Parafilm. The tube was then taken out of the glovebox, and quickly connected to a hydrogen flow furnace pre-purged with hydrogen. While flowing hydrogen (3 mL/min), the temperature was raised from room temperature to 250 °C at an average heating rate of 220 °C/h, held at 250 °C for 1.5 hours, and then cooled to room temperature. In this manner, the catalyst composition of Example 4, i.e., Co-supported perovskite-type oxyhydride (BaYO₂H, after sintering) with 2 wt % Co, was obtained.

### Example 5

### Production of Fe-Supported Perovskite-Type Oxyhydride (BaYO₂H, After Sintering)

In a glovebox filled with Ar, the perovskite-type oxyhydride (BaYO₂H, after sintering) of Example 2 and Fe₂(CO)₉ (99%, Thermo Fisher Scientific) were weighed to achieve an Fe loading of 2 wt % (65.1 mg of Fe₂(CO)₉ per 1 g of BaYO₂H) and mixed for about 10 minutes using a well-dried agate pestle and mortar. After mixing, the sample was filled into a glass reaction tube packed with quartz wool to close one end, sealed with Parafilm at both ends, and then taken out of the glovebox, and quickly connected to a hydrogen flow furnace pre-purged with hydrogen. While flowing hydrogen (5 mL/min), the temperature was raised to 200 °C at an average heating rate of 85 °C/min and held for 1 hour. Then, the temperature was raised from 200 °C to 400 °C at an average heating rate of 200 °C/h, held at 400 °C for 2 hours, and then cooled to room temperature. In this manner, the catalyst composition of Example 5, i.e., Fe-supported perovskite-type oxyhydride (BaYO₂H, after sintering) with 1 wt % Fe, was obtained.

### Comparative Example 1

CeO₂ was heated under vacuum at 600 °C to remove adsorbed water and other substances, and the dehydrated CeO₂ and Ba(NH₂)₂ were mixed in an Ar glovebox using an agate pestle and mortar, so that the charging molar ratio of Ce to Ba was 1:1. The obtained powder was heat-treated in an NH₃ gas flow at 600 °C for 6 hours. In this manner, BaCeO₃₋ₓN_{y}H_{z} powder was obtained.

0.50 g of powdered BaCeO₃₋ₓN_{y}H_{z} and 0.056 g of Ru₃(CO)₁₂ (Aldrich, 99%) (corresponding to a metal Ru loading rate of 5 mass % relative to BaCeO₃₋ₓN_{y}H_{z}) were placed in a silica glass tube, heated at 70 °C for 1 hour in a vacuum, and then heated at 120 °C for 1 hour to adhere Ru₃(CO)₁₂ to the surface of the powdered BaCeO₃₋ₓN_{y}H_{z}. The obtained product was finally heated at 250 °C for 2 hours to thermally decompose Ru₃(CO)₁₂, thereby fixing Ru to BaCeO₃₋ₓN_{y}H_{z}, obtaining the catalyst composition of Comparative Example 1 (Ru(5 wt %)/BaCeO₃₋ₓN_{y}H_{z}).

### Comparative Example 2

95 mg of powdered BaCeO₃₋ₓN_{y}H_{z} and 14.5 mg of Co₂(CO)₈ (corresponding to 5 mass % of metal Co loading rate relative to BaCeO₃₋ₓN_{y}H_{z}) were placed in a quartz glass reaction tube, and nitrogen gas at 15 mL/min and hydrogen gas at 45 mL/min (total 60 mL/min) were flowed through the reaction tube. The temperature was raised to 400 °C over 2 hours and held for 5 hours, thereby fixing Co to BaCeO₃₋ₓN_{y}H_{z}, obtaining the catalyst composition of Comparative Example 2 (Co(5 wt %)/BaCeO₃₋ₓN_{y}H_{z}).

### Comparative Example 3

95 mg of powdered BaCeO₃₋ₓN_{y}H_{z} and 16.3 mg of Fe₂(CO)₉ (corresponding to 5 mass % of metal Fe relative to BaCeO₃₋ₓN_{y}H_{z}) were placed in a quartz glass reaction tube, and nitrogen gas at 15 mL/min and hydrogen gas at 45 mL/min (total 60 mL/min) were flowed through the reaction tube. The temperature was raised to 400 °C over 2 hours and held for 5 hours, thereby fixing Fe to BaCeO₃₋ₓN_{y}H_{z}, obtaining the catalyst composition of Comparative Example 3 (Fe(5 wt %)/BaCeO₃₋ₓN_{y}H_{z}).

### Comparative Example 4

5.23 g (0.02 mol) of barium nitrate, 8.68 g (0.02 mol) of cerium nitrate hexahydrate, and 38.4 g (0.2 mol) of citric acid were dissolved in water, and 42.4 g (0.4 mol) of diethylene glycol was added to the resulting solution to obtain a mixture. The obtained mixture was stirred for 1 hour and then heated at 120 °C for 4 hours to form gel. The gelled mixture was then heated at 450 °C for 5 hours to carbonize it. The carbonized mixture was heated at 900 °C for 6 hours to obtain powdered BaCeO₃.

Using the same method as in Comparative Example 1, metal Ru was supported on BaCeO₃ at 5 mass %, obtaining the catalyst composition of Comparative Example 4 (Ru(5 wt %)/BaCeO₃).

### Comparative Example 5

Using the same method as in Comparative Example 1 except that Cs-added MgO (denoted as Cs/MgO) was used instead of BaCeO₃₋ₓN_{y}H_{z}, the catalyst composition of Comparative Example 5 (Ru(5 wt %)-Cs/MgO (Cs/Ru element ratio=1)) was obtained.

### Comparative Example 6

Using the same method as in Comparative Example 1 except that CeO₂ was used instead of BaCeO₃₋ₓN_{y}H_{z}, the catalyst composition of Comparative Example 6 (Ru(5 wt %)/CeO₂) was obtained.

### Comparative Example 7

Using the same method as described in WO2015/129471, the catalyst composition of Comparative Example 7 (Ru(5 wt %)/Ca₂N) was obtained.

### Comparative Example 8

Using the same method as described in WO2012/077658, the catalyst composition of Comparative Example 8 (Ru(2 wt %)/C12A7:e⁻) was obtained.

### Comparative Example 9

Ru/Ba₃Y₄O₉ was obtained by the following method.

Barium carbonate (>99%, Kojundo Chemical Laboratory Co., Ltd.) and yttrium oxide (>99.9%, Kojundo Chemical Laboratory Co., Ltd.) were mixed in air using an agate pestle and mortar, so that the charging molar ratio of barium carbonate to yttrium oxide was 3:2. The obtained powder was heat-treated in air at 1300 °C for 5 hours. In this manner, Ba₃Y₄O₉ powder was obtained. Then, using the same method as in Comparative Example 1 except that the obtained Ba₃Y₄O₉ was used instead of BaCeO₃₋ₓN_{y}H_{z}, the catalyst composition of Comparative Example 9 (Ru(2 wt %)/Ba₃Y₄O₉) was obtained.

### (X-Ray Diffraction (XRD))

An X-ray diffraction apparatus (MiniFlex600, Rigaku) was used, with Cu-Kα radiation (λ=0.15418 nm) as the X-ray source, a measurement range of 10-80°, a measurement interval of 0.02°, and a scan speed of 1-2°/min. Since the sample decomposes in air, it was placed in a sealed holder for air-unstable samples in a glovebox filled with Ar before measurement. The sample was subjected to Rietveld analysis of the XRD pattern using TOPAS (Bruker AXS) to identify the crystal phase.

### (Thermal Desorption Spectroscopy (TDS))

A high-vacuum thermal property measurement apparatus (TDS1400TV, ESCO) equipped with a quadrupole mass spectrometer (PrismaPlus QMG220, Pfeiffer Vacuum) was used, with a vacuum level of 10⁻⁴ to 10⁻⁷ Pa, an infrared heat source, a heating rate of 60 °C/min, a holding temperature of 1200 °C, and an SEM voltage of 1200 V. The sample was placed in a SiO₂ holder (approximately 1-3 mg) in a glovebox filled with Ar and transferred to the apparatus using a dedicated transfer vessel. In order to confirm that it is a hydride and to investigate hydrogen release characteristics, the fragment with a mass-to-charge ratio of 2 derived from hydrogen in the obtained TDS spectrum was focused on to examine the presence or absence of the included hydrogen and amount of the included hydrogen from its desorption temperature and desorption amount. Furthermore, since hydrides are often hydroxylated by water in the atmosphere, the fragment with a mass-to-charge ratio of 18 derived from water was also analyzed to confirm the presence or absence of hydroxylation. The TDS spectrum was analyzed using TDS Data Viewer (ESCO).

### (Nitrogen Adsorption Measurement)

Measurements were performed in the relative pressure range of 0-0.4, by using a specific surface area measurement apparatus (BELSORP mini, MicrotracBEL). The sample was filled into a sealed sample tube (approximately 0.1 g) in a glovebox filled with Ar and connected to the apparatus without exposure to air. Nitrogen adsorption measurement was performed, and the BET specific surface area was calculated using the Brunauer-Emmett-Teller (BET) equation shown in the following Equation (3). Here, Va is the adsorption amount at equilibrium pressure, Vₘ is the monolayer adsorption amount, p₀ is the saturated vapor pressure, p is the equilibrium pressure, and C is a parameter related to the difference in adsorption heat between the first layer and subsequent layers. Specifically, the specific surface area of each sample was calculated by plotting based on the Brunauer-Emmett-Teller (BET) equation so that the C in BET equation was set to be approximately 50-300, as recommended for liquid nitrogen temperature, in the relative pressure range of 0.05-0.35, where the BET equation holds well. The BET specific surface area of the perovskite-type oxyhydride of Example 1 was 2.60 m²/g. The BET specific surface area of the perovskite-type oxyhydride of Example 2 was 2.17 m²/g. The BET specific surface area of the perovskite-type oxyhydride of Example 3 was 4.38 m²/g.

$$\frac{p}{{V}_{a} ( {p}_{0} - p )} = \frac{1}{{V}_{m} C} + \frac{( C - 1 )}{{V}_{m} C} \frac{p}{{p}_{0}} \qquad ( 3 )$$

### (Heat Resistance Evaluation Test)

The heat resistance of the perovskite-type oxyhydride of Example 1 was evaluated by heat treatment in a hydrogen atmosphere. Specifically, the perovskite-type oxyhydride of Example 1 was placed in an alumina Tammann tube, and the tube was loaded into a vessel with a needle valve. And the vessel was then taken out of the glovebox without exposure to air, and attached to a hydrogen furnace. After hydrogen replacement in the vessel, the vessel was heated at various temperatures (500 °C, 550 °C, 600 °C, 700 °C, or 800 °C). After holding for 72 hours and cooling to room temperature, XRD measurement was performed on the extracted sample.

### (Ammonia Synthesis)

The ammonia synthesis test was conducted by flowing nitrogen gas and hydrogen gas at a flow rate of 15 mL/min and 45 mL/min, respectively, so that a flow rate ratio is 1:3, with a catalyst loading amount standardized at 0.1 g. The reaction time was 0-80 hours, the temperature was 200-400 °C, and the pressure was 0.1-0.9 MPa. The gas passing through the catalyst was passed through 5 mM dilute sulfuric acid to trap ammonia as ammonium ions, which were sampled at regular intervals and measured by ion chromatography (Prominence, Shimadzu), and as a result qualitative and quantitative analysis of the ammonia was performed. The ammonia synthesis rate was calculated from the slope of the plot of the amount of ammonium ions generated against the sampling time.

### (Ammonia Decomposition)

The ammonia decomposition test was conducted by flowing ammonia at a flow rate of 25 mL/min, with a catalyst loading amount standardized at 0.1 g. The reaction time was 0-80 hours, the temperature was 220-520 °C, and the pressure was 0.1 MPa. The ammonia conversion was determined by measuring the gas passing through the catalyst using gas chromatography (GC-14A, Shimadzu). The ammonia conversion is the percentage whose denominator is “the amount of NH₃ fed before decomposition” and whose numerator is “(the amount of NH₃ fed before decomposition)−(the amount of residual NH₃ recovered after decomposition).”

FIG. 2 shows the XRD patterns of the perovskite-type oxyhydride of Example 1 (BaYO₂H, before sintering) and the perovskite-type oxyhydride of Example 2 (BaYO₂H, after sintering). The horizontal axis of FIG. 2 is 20 (°), and the vertical axis is diffraction intensity (a.u.) (arbitrary units). As shown in FIG. 2, for both Examples 1 and 2, diffraction lines considered to be derived from BaYO₂H and slight diffraction lines derived from Y₂O₃ were observed. Since no diffraction lines from raw materials other than Y₂O₃ were observed, the observed diffraction lines derived from Y₂O₃ are presumed to be residual material. Rietveld analysis was performed on the perovskite-type oxyhydride of Example 2. At this time, it was assumed that BaYO₂H has the same crystal structure as BaScO₂H, which has been reported to be synthesized as a cubic perovskite-type oxyhydride. Using a structure created by replacing Sc with Y in the structure of BaScO₂H as a template, parameters such as lattice constants were optimized, and it was confirmed that the XRD pattern of the perovskite-type oxyhydride of Example 2 showed good agreement with the pattern calculated from the optimized structure. From the obtained results, it was confirmed that the perovskite-type oxyhydride of Example 1 and the perovskite-type oxyhydride of Example 2 are BaYO₂H (cubic).

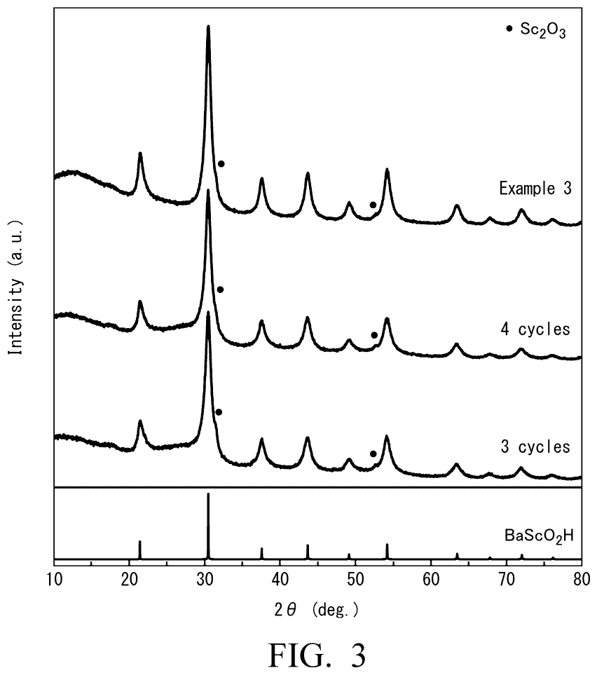

FIG. 3 shows the XRD patterns of the perovskite-type oxyhydride of Example 3 (BaScO₂H, before sintering) after three reaction cycles, after four reaction cycles, and the perovskite-type oxyhydride of Example 3 (BaScO₂H, after sintering). The horizontal axis of FIG. 3 is 20 (°), and the vertical axis is diffraction intensity (a.u. (arbitrary units)). As shown in FIG. 3, diffraction lines considered to be derived from BaScO₂H and slight diffraction lines derived from Sc₂O₃ were observed. Since no change was observed in the diffraction lines derived from Sc₂O₃ between the third and fourth reaction cycles, the observed diffraction lines derived from Sc₂O₃ are presumed to be residual material. Rietveld analysis was performed on the XRD pattern of the perovskite-type oxyhydride of Example 3, and it showed good agreement with the pattern calculated from the already reported crystal structure of BaScO₂H. From the obtained results, it was confirmed that the perovskite-type oxyhydride of Example 3 is BaScO₂H (cubic).

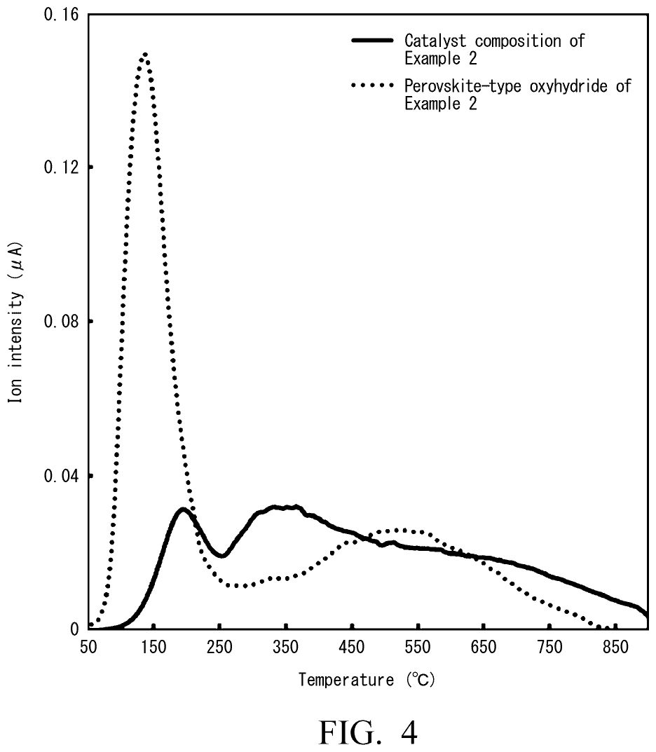

FIG. 4 shows the TDS measurement results for both the perovskite-type oxyhydride of Example 2 (BaYO₂H, after sintering) and the catalyst composition of Example 2 (i.e., Ru-supported perovskite-type oxyhydride (BaYO₂H, after sintering)). The horizontal axis is temperature (°C), and the vertical axis is ion current (A). For the perovskite-type oxyhydride of Example 2, strong hydrogen desorption was observed at 50-250 °C and above 350 °C. On the other hand, almost no fragment with a mass-to-charge ratio of 18 derived from H₂O was observed. When H₂ and H₂O were quantified from the integrated values of these fragments in the range where quantitativeness is ensured (during heating), H₂ was at the same scale as the ideal value, and H₂O was about 2% of H₂, suggesting that BaYO₂H is a pure hydride not subjected to hydroxylation. Additionally, since hydrogen desorption was observed even at low temperatures of 200 °C or less, it is possible that reversible hydrogen exchange occurs under on-site ammonia conditions (400 °C or less), confirming its suitability as a support for a catalyst for ammonia synthesis reactions.

For the catalyst composition of Example 2, it was confirmed that the hydrogen desorption peak in the low-temperature range (50-200 °C) shifted to the higher temperature side, and the hydrogen desorption peak in the high-temperature range (above 350 °C) shifted to the lower temperature side. It is known that the Ru surface has strong hydrogen adsorption, causing hydrogen poisoning that inhibits nitrogen adsorption by covering the Ru surface with dissociated hydrogen atoms at low temperatures of 400 °C or less. Therefore, the peak shift in the low-temperature range is presumed to be due to a change in the form of hydrogen desorption from direct desorption from the BaYO₂H surface to reverse spillover of hydrogen from the perovskite-type oxyhydride surface to the supported Ru surface. Here, reverse spillover refers to a phenomenon in catalysts composed of a metal and a support where atoms or ions adsorbed on the support move to the surface of the supported metal through diffusion and recombine to desorb into the gas phase as molecules. On the other hand, the peak shift in the high-temperature range indicates that hydrogen diffusion from the bulk to the surface is facilitated, suggesting that hydrogen diffusion in the bulk is also promoted along with the promotion of hydrogen diffusion near the surface due to Ru support. Overall, since the spectrum shape changed to show uniform hydrogen desorption across the entire temperature range above 150 °C, it was suggested that catalytic activity is exhibited in the temperature range above 150 °C, and the activity may improve with increasing temperature as long as BaYO₂H does not decompose.

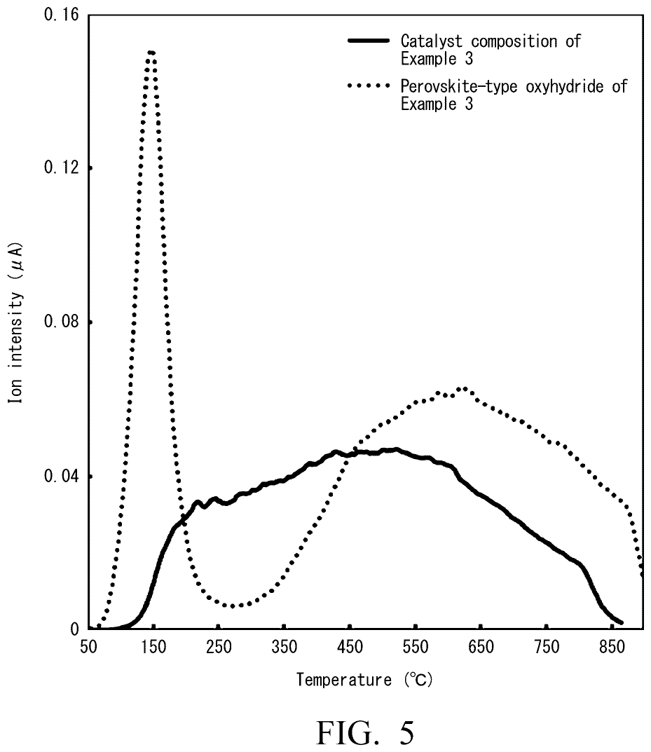

FIG. 5 shows the TDS measurement results for both the perovskite-type oxyhydride of Example 3 (BaScO₂H, after sintering) and the catalyst composition of Example 3 (i.e., Ru-supported perovskite-type oxyhydride (BaScO₂H, after sintering)). The horizontal axis is temperature (°C), and the vertical axis is ion current (A). For the perovskite-type oxyhydride of Example 3, strong hydrogen desorption was observed at 100-200 °C and above 350 °C. On the other hand, almost no fragment with a mass-to-charge ratio of 18 derived from H₂O was observed. When H₂ and H₂O were quantified from the integrated values of these fragments in the range where quantitativeness is ensured (during heating), H₂O was less than 1% of H₂, suggesting that BaScO₂H is a pure hydride not subjected to hydroxylation. Additionally, since hydrogen desorption was observed even at low temperatures of 200 °C or less, it is possible that reversible hydrogen exchange occurs under on-site ammonia conditions (400 °C or less), confirming its suitability as a support for a catalyst for ammonia synthesis reactions.

For the catalyst composition of Example 3, as in the case of Example 2, it was confirmed that the hydrogen desorption peak in the low-temperature range (50-200 °C) shifted to the higher temperature side, and the hydrogen desorption peak in the high-temperature range (above 350 °C) shifted to the lower temperature side. Overall, since the spectrum shape changed to show uniform hydrogen desorption across the entire temperature range above 150 °C, it was suggested that catalytic activity is exhibited in the temperature range above 150 °C, and the activity may improve with increasing temperature as long as BaScO₂H does not decompose.

### (Heat Resistance Test)

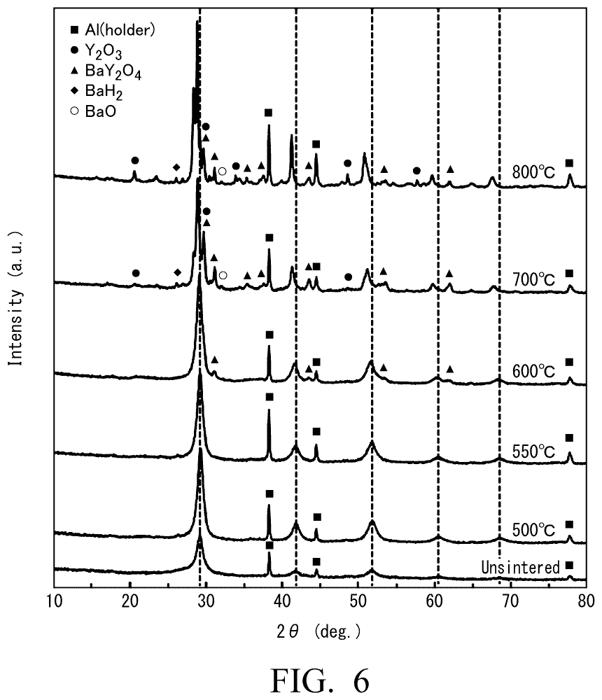

FIG. 6 shows the results of XRD measurement performed on the perovskite-type oxyhydrides obtained after heat-treating the perovskite-type oxyhydride of Example 1 (BaYO₂H, before sintering) in a hydrogen atmosphere at various temperatures for 72 hours. The horizontal axis of FIG. 6 is 20 (°), and the vertical axis represents diffraction intensity (a.u. (arbitrary units)). It was confirmed that BaY₂O₄, BaO, BaH₂, and Y₂O₃ precipitated at 600 °C or higher, suggesting that BaYO₂H decomposed. Additionally, it was confirmed that the half-width of the diffraction lines considered to be derived from BaYO₂H decreased with increasing temperature, indicating improved crystallinity, and it was also confirmed that the lattice expanded suggesting the compensation of hydrogen defects.

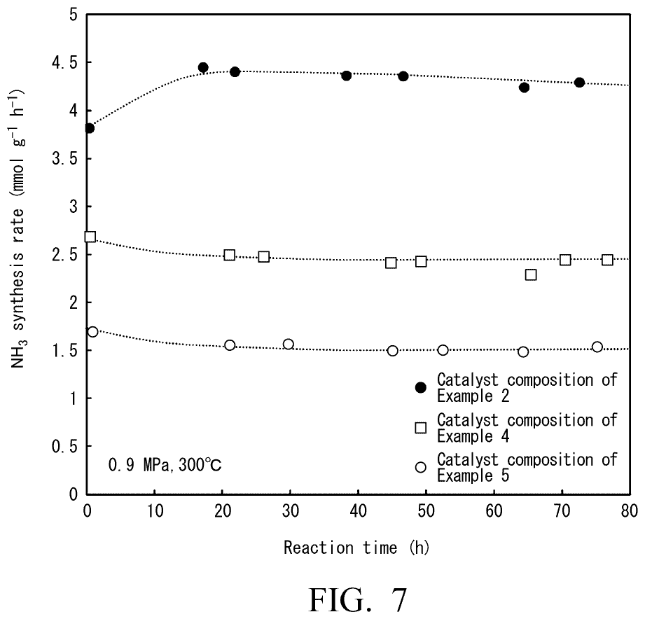

FIG. 7 shows the time-course changes in ammonia (NH₃) synthesis rate (mmol g⁻¹ h⁻¹) for the catalyst composition of Example 2 (i.e., Ru-supported perovskite-type oxyhydride (BaYO₂H, after sintering)), the catalyst composition of Example 4 (i.e., Co-supported perovskite-type oxyhydride (BaYO₂H, after sintering)), and the catalyst composition of Example 5 (i.e., Fe-supported perovskite-type oxyhydride (BaYO₂H, after sintering)) when exposed to a mixed gas flow of H₂ and N₂ (H₂:N₂=3:1) at 0.9 MPa and 300 °C. The horizontal axis of FIG. 7 is reaction time (h), and the vertical axis is the ammonia synthesis rate (mmol g⁻¹ h⁻¹). For the catalyst composition of Example 2, the ammonia synthesis rate increased until 20 hours and then showed stable behavior thereafter. On the other hand, for the catalyst compositions of Examples 4 and 5, the ammonia synthesis rate decreased until 20 hours and then showed stable behavior thereafter. Additionally, the catalyst composition of Example 2 had the highest ammonia synthesis rate, followed by the catalyst composition of Example 4. The catalyst composition of Example 5 had the lowest ammonia synthesis rate.

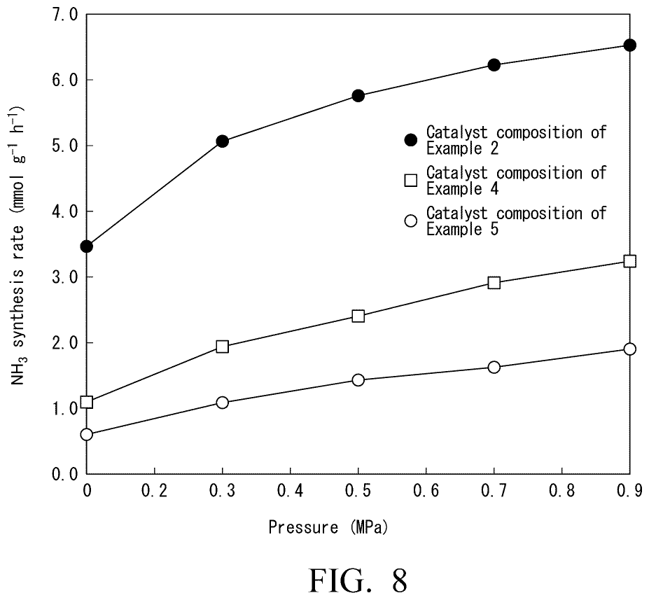

FIG. 8 shows the pressure dependence of the ammonia (NH₃) synthesis rate (mmol g⁻¹ h⁻¹) for the catalyst composition of Example 2 (i.e., Ru-supported perovskite-type oxyhydride (BaYO₂H, after sintering)), the catalyst composition of Example 4 (i.e., Co-supported perovskite-type oxyhydride (BaYO₂H, after sintering)), and the catalyst composition of Example 5 (i.e., Fe-supported perovskite-type oxyhydride (BaYO₂H, after sintering)) when exposed to a mixed gas flow of H₂ and N₂ (H₂:N₂=3:1) at 320 °C. The horizontal axis of FIG. 8 is pressure (MPa), and the vertical axis is the ammonia synthesis rate (mmol g⁻¹ h⁻¹). As shown in FIG. 8, for the catalyst compositions of Examples 2, 4, and 5, the ammonia synthesis rate increased as the pressure increased. In particular, for the catalyst compositions of Examples 4 and 5, the ammonia synthesis rate tripled when the pressure was increased from 0.1 MPa to 0.9 MPa.

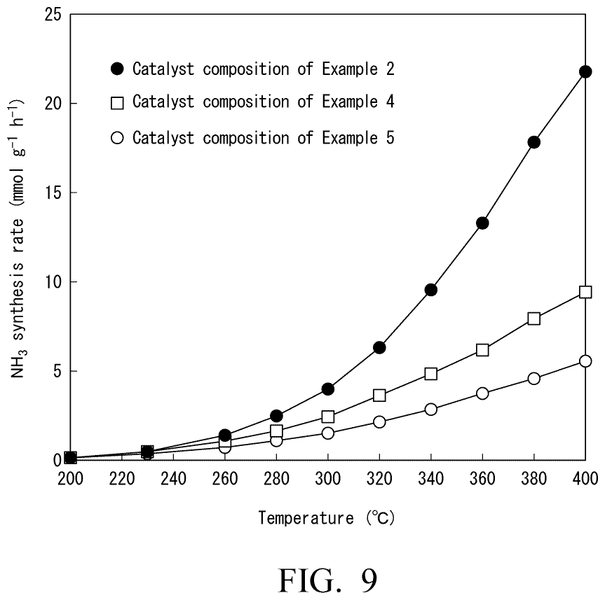

FIG. 9 shows the temperature dependence of the ammonia (NH₃) synthesis rate (mmol g⁻¹ h⁻¹) for the catalyst composition of Example 2 (i.e., Ru-supported perovskite-type oxyhydride (BaYO₂H, after sintering)), the catalyst composition of Example 4 (i.e., Co-supported perovskite-type oxyhydride (BaYO₂H, after sintering)), and the catalyst composition of Example 5 (i.e., Fe-supported perovskite-type oxyhydride (BaYO₂H, after sintering)) when exposed to a mixed gas flow of H₂ and N₂ (H₂:N₂=3:1) at 0.9 MPa. The horizontal axis of FIG. 9 is temperature (°C), and the vertical axis is the ammonia synthesis rate (mmol g⁻¹ h⁻¹). The ammonia synthesis rate for the catalyst compositions of Examples 2, 4, and 5 increased with increasing temperature.

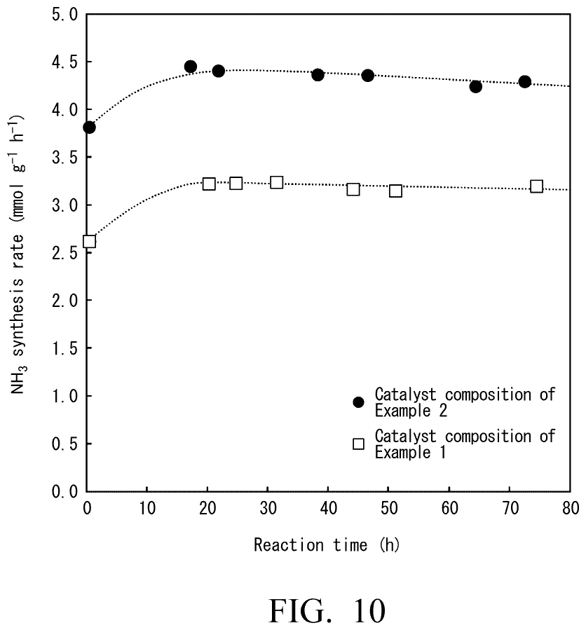

FIG. 10 shows the time-course changes in the ammonia synthesis rate for the catalyst composition of Example 1 (i.e., Ru-supported perovskite-type oxyhydride (BaYO₂H, before sintering)) and the catalyst composition of Example 2 (i.e., Ru-supported perovskite-type oxyhydride (BaYO₂H, after sintering)) when exposed to a mixed gas flow of H₂ and N₂ (H₂:N₂=3:1) at 0.9 MPa and 300 °C. The horizontal axis of FIG. 10 is time (h), and the vertical axis is the ammonia synthesis rate (mmol g⁻¹ h⁻¹). It was confirmed that the catalyst compositions of Examples 1 and 2 showed similar behavior regardless of sintering. Additionally, the ammonia synthesis rate for the catalyst composition of Example 2 was higher than that for the catalyst composition of Example 1.

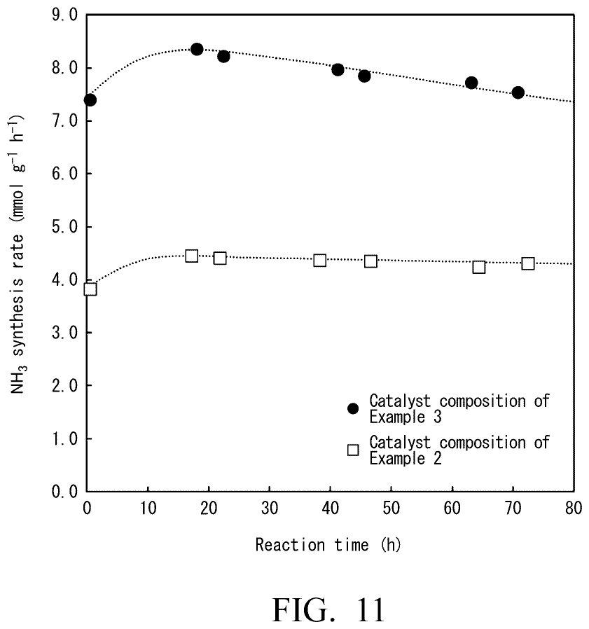

FIG. 11 shows the time-course changes in the ammonia synthesis rate for the catalyst composition of Example 2 (i.e., Ru-supported perovskite-type oxyhydride (BaYO₂H, after sintering)) and the catalyst composition of Example 3 (i.e., Ru-supported perovskite-type oxyhydride (BaScO₂H, after sintering)). The horizontal axis of FIG. 11 is reaction time (h), and the vertical axis is the ammonia synthesis rate (mmol g⁻¹ h⁻¹). For the catalyst composition of Example 3, the ammonia synthesis rate slightly increased from the value measured immediately after reaching the target temperature and then gradually decreased after 20 hours. On the other hand, for the catalyst composition of Example 2, the behavior of the ammonia synthesis rate until 20 hours was similar to that of the catalyst composition of Example 3, but after 20 hours, the ammonia synthesis rate remained constant. Therefore, it was found that the catalyst composition of Example 2 is effective for synthesizing ammonia over a longer period.

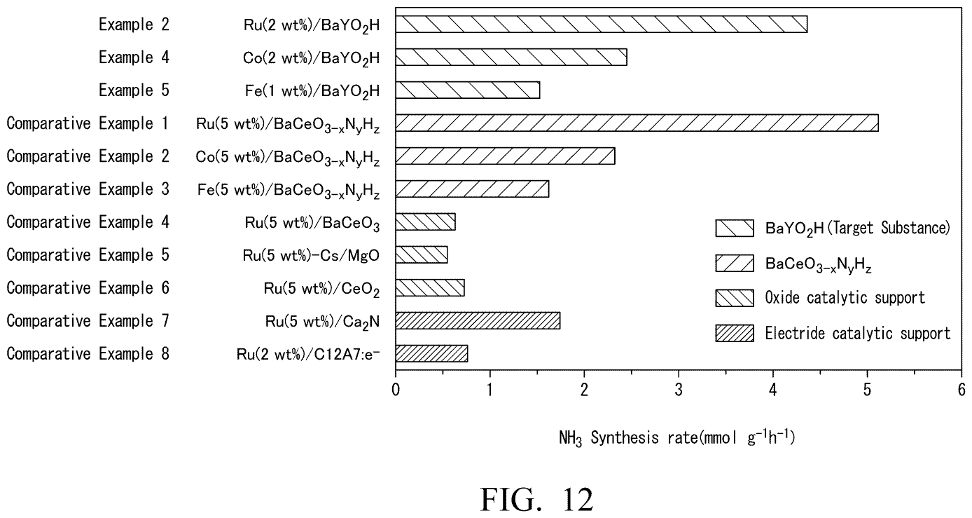

FIG. 12 shows the ammonia synthesis rate for the catalyst composition of Example 2 (i.e., Ru-supported perovskite-type oxyhydride (BaYO₂H, after sintering)), the catalyst composition of Example 4 (i.e., Co-supported perovskite-type oxyhydride (BaYO₂H, after sintering)), the catalyst composition of Example 5 (i.e., Fe-supported perovskite-type oxyhydride (BaYO₂H, after sintering)), and the catalyst compositions of Comparative Examples 1-8 when exposed to a mixed gas flow of H₂ and N₂ (H₂:N₂=3:1) at 0.9 MPa and 300 °C. Comparative Examples 1-8 are existing catalyst compositions. The ammonia synthesis rate for the catalyst composition of Example 2 was higher than the ammonia synthesis rates for Comparative Examples 2-8, which also supported Ru. Additionally, although the Ru loading in the catalyst composition of Example 2 was less than half that of Comparative Example 1, the ammonia synthesis rate of Example 2 was comparable to that of Comparative Example 1. From the above, it was confirmed that the catalyst composition of the present disclosure is suitable for ammonia synthesis reactions.

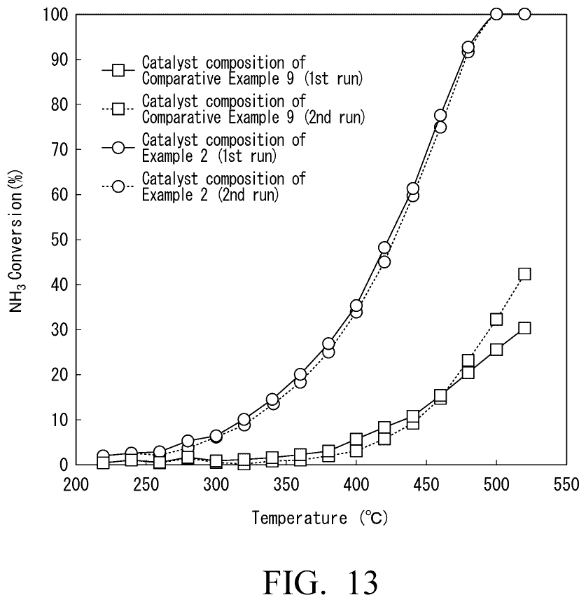

FIG. 13 shows the temperature dependence of the ammonia conversion for the catalyst composition of Example 2 (i.e., Ru-supported perovskite-type oxyhydride (BaYO₂H, after sintering)) and the catalyst composition of Comparative Example 9 when exposed to ammonia at 0.1 MPa. For both the catalyst composition of Example 2 and the catalyst composition of Comparative Example 9, the ammonia conversion increased as the temperature increased. Additionally, the catalyst composition of Example 2 showed a higher conversion rate. From the above, it was confirmed that the catalyst composition of the present disclosure is suitable for ammonia decomposition reactions.

### Example 6

Production of Perovskite-Type Oxyhydride (BaTbO₂H, BaDyO₂H, BaHoO₂H, BaErO₂H, BaYbO₂H, BaLuO₂H, Before Sintering)

Using Tb₂O₃, Dy₂O₃, Ho₂O₃, Er₂O₃, Yb₂O₃, and Lu₂O₃ (all 99.9%, Kojundo Chemical Laboratory Co., Ltd.) instead of Y₂O₃, the perovskite-type oxyhydrides (BaTbO₂H, BaDyO₂H, BaHoO₂H, BaErO₂H, BaYbO₂H, and BaLuO₂H, before sintering) of Example 6 were obtained in the same manner as in Example 1.

### Example 7

Production of Perovskite-Type Oxyhydride (BaTbO₂H, BaDyO₂H, BaHoO₂H, BaErO₂H, BaYbO₂H, BaLuO₂H, After Sintering)

Using the perovskite-type oxyhydrides (BaTbO₂H, BaDyO₂H, BaHoO₂H, BaErO₂H, BaYbO₂H, BaLuO₂H, before sintering) of Example 6 instead of the perovskite-type oxyhydride (BaYO₂H, before sintering) of Example 1, the perovskite-type oxyhydrides (BaTbO₂H, BaDyO₂H, BaHoO₂H, BaErO₂H, BaYbO₂H, BaLuO₂H, after sintering) of Example 7 were obtained in the same manner as in Example 2.

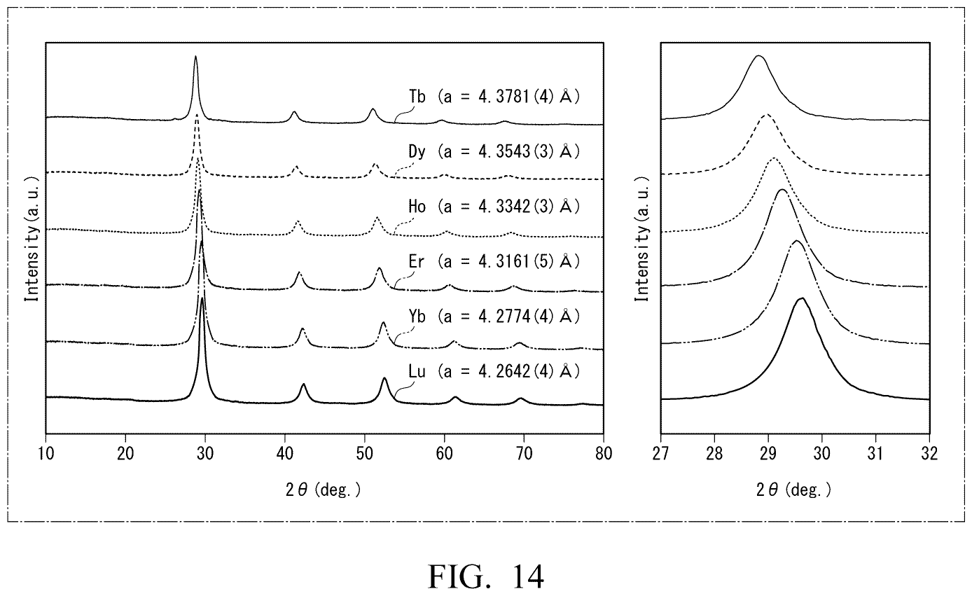

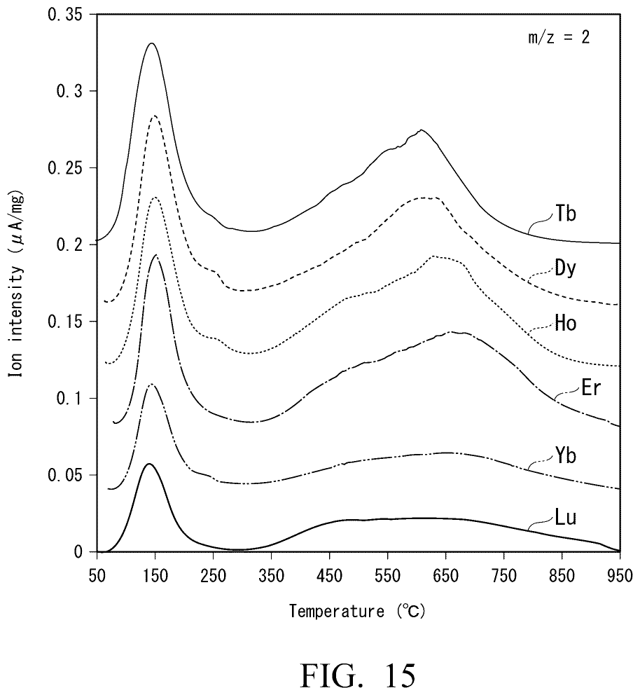

XRD and TDS measurements were performed in the same manner as for the perovskite-type oxyhydride of Example 2 (BaYO₂H, after sintering). The results are shown in FIGS. 14 and 15.

### Example 8

Production of Ru-Supported Perovskite-Type Oxyhydride (BaTbO₂H, BaDyO₂H, BaHoO₂H, BaErO₂H, BaYbO₂H, BaLuO₂H, After Sintering)

Using the perovskite-type oxyhydrides (BaTbO₂H, BaDyO₂H, BaHoO₂H, BaErO₂H, BaYbO₂H, BaLuO₂H, after sintering) obtained in Example 7 instead of the perovskite-type oxyhydride (BaYO₂H, after sintering) of Example 2, the catalyst compositions of Example 8, i.e., Ru-supported perovskite-type oxyhydrides (BaTbO₂H, BaDyO₂H, BaHoO₂H, BaErO₂H, BaYbO₂H, BaLuO₂H, after sintering) with 2 wt % Ru, were obtained in the same manner as in Example 2.

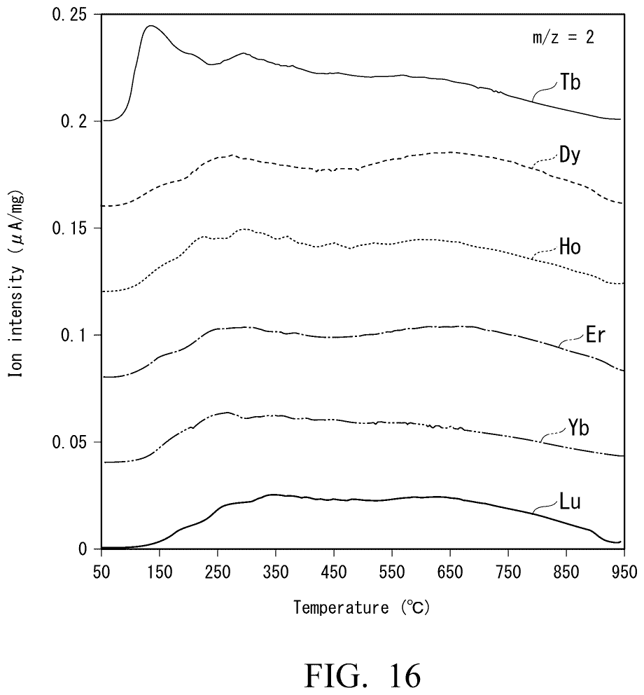

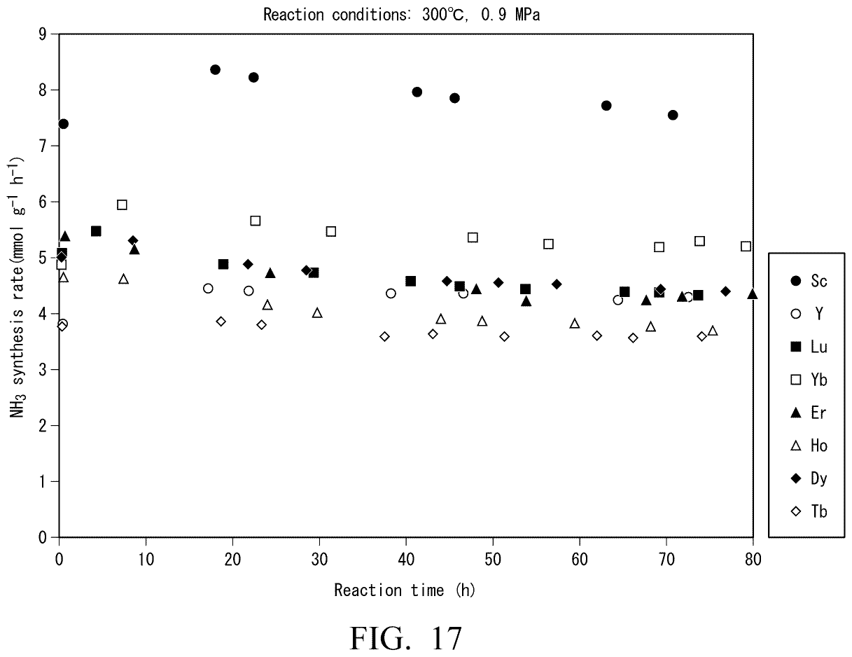

TDS, time-course changes in ammonia synthesis rate, and catalytic activity measurements were performed in the same manner as for the catalyst composition of Example 2 (i.e., Ru-supported perovskite-type oxyhydride (BaYO₂H, after sintering)). The results are shown in FIGS. 16, 17, 18, and Table 1.

TABLE 1

| | | Ru | Ammonia |
|---|---|---|---|
| | Ru | Particle | Synthesis |
| | Loading | Size | Rate |
| Catalyst | (wt %) | (nm) | (mmol g⁻¹ h⁻¹) |
| Ru/BaTbO₂H | 1.5 | 17.9 | 3.60 |
| Ru/BaDyO₂H | 1.7 | 16.8 | 4.48 |
| Ru/BaHoO₂H | 1.8 | 14.8 | 3.83 |
| Ru/BaErO₂H | 1.7 | 12.8 | 4.29 |
| Ru/BaYbO₂H | 2.0 | 14.1 | 5.23 |
| Ru/BaLuO₂H | 1.9 | 11.4 | 4.39 |
| Ru/BaYO₂H | 1.8 | 8.6 | 4.35 |
| Ru/BaScO₂H | 1.6 | 6.3 | 7.87 |

In Table 1, the Ru loading was determined using X-ray fluorescence (XRF) analysis. XRF measurements were performed using a wavelength-dispersive X-ray fluorescence spectrometer S8 TIGER (Bruker) under the conditions shown below.

### (XRF Measurement Conditions)

Apparatus: Wavelength-dispersive X-ray fluorescence spectrometer S8 TIGER (Bruker)
X-ray source: Rh-Lα line
Diffraction crystal: LiF(200)
Atmosphere: Vacuum
Collimator mask (X-ray irradiation range): Circle with a diameter of 5 mm
Target elements: Ba, RE, Ru
Quantitative method: Fundamental parameter (FP) method (i.e., a method of estimating the elemental composition so that a calculated value matches the measured fluorescent X-ray intensity, wherein the calculated value is obtained by theoretically calculating the fluorescence X-ray intensity from the types and amounts of the constituent elements.)

Since the ratio of Ru/Ba or Ru/RE is obtained as a weight ratio from XRF measurement, the Ru loading wt % (100×Ru[g]/(Ru[g]+Support[g])) can be determined if the content of Ba or RE per unit weight of the support is known (which corresponds to the weight of each element contained in the raw materials used to synthesize BaREO₂H). In Table 1, the Ru loading is calculated from the weight ratio of RE and Ru, where the fluorescence X-ray intensity is high and the influence of matrix-induced intensity changes is small.

### (As One Example)

When Ru/Y=0.0541 and Y content per 1 g of support=0.343 g,
weight of Ru per 1 g of support=0.0541×0.343=0.0186 g, and then
Ru loading=100×0.0186/(0.0186+1)=1.8 wt %.

In Table 1, the “Ru particle size” was estimated by CO chemisorption measurement (CO:Ru=1:1). The measurement of CO chemisorption amount was performed using a BELCAT-A apparatus (MicrotracBEL) under the conditions shown below.
Apparatus: Catalyst analyzer BELCAT-A (MicrotracBEL)
Measurement temperature: 50 °C
Carrier gas: He (30 mL/min)
Adsorbed gas: CO/He (9.51%)
Pulse volume: 0.031 mL
Sample amount: Approximately 0.15-0.2 g
Pretreatment: Heating at 400 °C in a hydrogen atmosphere for 2 hours. Then, switching the gas to He and heating at 400 °C for 30 minutes. (Since Ru was supported using Ru₃(CO)₁₂ as a precursor, CO is already adsorbed on the Ru surface before measurement, making it impossible to measure the CO adsorption amount directly. Therefore, the adsorbed CO is removed by heating in a hydrogen flow. Additionally, since hydrogen adsorption on Ru is strong and hydrogen adsorbed on Ru remains with only hydrogen flow, He is flowed to remove the adsorbed hydrogen. By performing these pretreatments, a clean Ru surface free of adsorbed species is obtained. In the actual measurement, the CO adsorption amount is obtained as a measured value, and the Ru particle size and dispersion are calculated from the sample loading amount and the Ru loading input value (which is automatically calculated in the software: ChemMaster)).

### DISCUSSION

From the results in Table 1, the actual Ru loading for all catalyst compositions was in the range of 1.5-2.0 wt %. Additionally, the Ru particle size was smallest when RE was Sc, and a trend was observed where the Ru particle size increased as the ionic radius of RE increased, with the largest size observed when RE was Tb. Since no correlation was observed between the Ru loading and the Ru particle size, this trend may be due to differences in the surface properties of the support or the interaction between the support and Ru (e.g., specific surface area, surface roughness, Ru adsorption energy).

FIG. 14 shows the XRD patterns of the perovskite-type oxyhydrides of Example 7 (BaTbO₂H, BaDyO₂H, BaHoO₂H, BaErO₂H, BaYbO₂H, BaLuO₂H, after sintering). The horizontal axis of FIG. 14 is 20 (°), and the vertical axis is diffraction intensity (a.u. (arbitrary units)). As shown in FIG. 14, it was confirmed that each of the perovskite-type oxyhydrides of Example 7 was BaTbO₂H (cubic), BaDyO₂H (cubic), BaHoO₂H (cubic), BaErO₂H (cubic), BaYbO₂H (cubic), and BaLuO₂H (cubic).

Additionally, it was confirmed that diffraction lines derived from a cubic perovskite structure were obtained for all samples, and that as the atomic number of RE increased from Tb to Lu, the diffraction peaks of RE shifted to the higher angle side and the lattice constant decreased. The results reflect the decrease in ionic radius due to lanthanoid contraction.

FIG. 15 shows the TDS measurement results for the perovskite-type oxyhydrides of Example 7 (BaTbO₂H, BaDyO₂H, BaHoO₂H, BaErO₂H, BaYbO₂H, BaLuO₂H, after sintering). The horizontal axis is temperature (°C), and the vertical axis is ion current normalized by sample weight (A/mg).

From the results in FIG. 15, hydrogen desorption was confirmed in all samples, and it was confirmed that the samples are pure hydrides containing no hydroxyl groups (OH⁻). Additionally, since similar spectral shapes indicating hydrogen desorption were obtained in all samples in the temperature range of 100 °C or more and 200 °C or less and the temperature range of 350 °C or more, it is considered that there is no significant difference in hydrogen desorption ability between different materials.

FIG. 16 shows the TDS measurement results for the catalyst composition of Example 8 (i.e., Ru-supported perovskite-type oxyhydrides (BaTbO₂H, BaDyO₂H, BaHoO₂H, BaErO₂H, BaYbO₂H, BaLuO₂H, after sintering)). The horizontal axis is temperature (°C), and the vertical axis is ion current normalized by sample weight (A/mg).

From the results in FIG. 16, by supporting Ru, the spectral shape changed to show uniform hydrogen desorption across the entire temperature range above 100 °C, suggesting that catalytic activity is exhibited in the temperature range above 100 °C, and the activity may improve with increasing temperature as long as the support does not decompose.

FIG. 17 shows the time-course changes in ammonia (NH₃) synthesis rate (mmol g⁻¹ h⁻¹) for the catalyst composition of Example 8 (i.e., Ru-supported perovskite-type oxyhydrides (BaTbO₂H, BaDyO₂H, BaHoO₂H, BaErO₂H, BaYbO₂H, BaLuO₂H, after sintering)) when exposed to a mixed gas flow of H₂ and N₂ (H₂:N₂=3:1) at 0.9 MPa and 300 °C. The horizontal axis of FIG. 17 is reaction time (h), and the vertical axis is the ammonia synthesis rate (mmol g⁻¹ h⁻¹).

From the results in FIG. 17, for the catalyst compositions of Example 8, although there are slight differences in the behavior of changes in the ammonia synthesis rate with time, for each of Ru/BaTbO₂H, Ru/BaDyO₂H, Ru/BaHoO₂H, BaErO₂H, BaYbO₂H, and Ru/BaLuO₂H, a constant ammonia synthesis rate was shown after 40 hours from the start of the reaction. This confirms that the above catalyst compositions are also suitable for long-term ammonia synthesis.

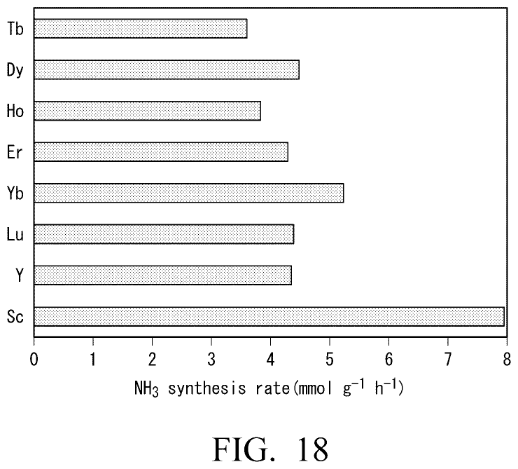

FIG. 18 shows the ammonia synthesis rate for the catalyst composition of Example 8 (i.e., Ru-supported perovskite-type oxyhydrides (BaTbO₂H, BaDyO₂H, BaHoO₂H, BaErO₂H, BaYbO₂H, BaLuO₂H, after sintering)), the catalyst composition of Example 2 (i.e., Ru-supported perovskite-type oxyhydride (BaYO₂H, after sintering)), and the catalyst composition of Example 3 (i.e., Ru-supported perovskite-type oxyhydride (BaScO₂H, after sintering)) when exposed to a mixed gas flow of H₂ and N₂ (H₂:N₂=3:1) at 0.9 MPa and 300 °C.

From the results in FIG. 18, it was confirmed that all samples showed high ammonia synthesis rates. In particular, the ammonia synthesis rate when RE was Sc was remarkably high. From the results in Table 1, the Ru particle size when RE was Sc was about ¾ compared to that when RE was Y, and about ½ to ⅓ compared to those when RE was lanthanides from Tb to Lu. Therefore, it is expected that the number of catalytic reaction active sites, when RE is Sc, is greater than those in other catalyst compositions, and as a result, a remarkably high ammonia synthesis rate has been achieved.

### REFERENCE SIGNS LIST

S1: First Step;
S2: Second Step.

What is claimed is:

1. A perovskite-type oxyhydride represented by the following formula (1):
BaREO₂Hₘ (1)
wherein, in formula (1), RE represents at least one rare earth element selected from the group consisting of Y, Sc, Gd, Tb, Dy, Ho, Er, Tm, Yb, and Lu, and m represents a value in the range of 0.5 to 1.0.

2. The perovskite-type oxyhydride according to claim 1, wherein RE is at least one rare earth element selected from the group consisting of Y, Sc, Tb, Dy, Ho, Er, Yb, and Lu.

3. The perovskite-type oxyhydride according to claim 1, wherein RE is Y or Sc.

4. (canceled)

5. A catalyst composition comprising the perovskite-type oxyhydride according to claim 1 and one or more transition metals, wherein the perovskite-type oxyhydride supports the transition metals selected from the group consisting of Ru, Co, Fe, Cr, and Mn.

6. An ammonia synthesis method comprising a step of reacting nitrogen with hydrogen in the presence of the perovskite-type oxyhydride according to claim 1.

7. An ammonia decomposition method comprising a step of decomposing ammonia into hydrogen and nitrogen in the presence of the perovskite-type oxyhydride according to claim 1.

8. A method for producing a perovskite-type oxyhydride represented by the following formula (1):
BaREO₂Hₘ (1)
wherein, in formula (1), RE represents at least one rare earth element selected from the group consisting of Y, Sc, Gd, Tb, Dy, Ho, Er, Tm, Yb, and Lu, and m represents a value in the range of 0.5 to 1.0,
the method comprises a step of repeatedly performing crimping and pulverization under an inert gas atmosphere using a mechanochemical method on raw materials comprising BaO, BaH₂, and a compound represented by the following formula (2):
RE₂O₃ (2)
wherein, in formula (2), RE represents at least one rare earth element selected from the group consisting of Y, Sc, Gd, Tb, Dy, Ho, Er, Tm, Yb, and Lu,
until refined and homogeneous particles of a synthesis reaction product are formed.

9. The method for producing a perovskite-type oxyhydride according to claim 8, wherein RE is at least one rare earth element selected from the group consisting of Y, Sc, Tb, Dy, Ho, Er, Yb, and Lu.

10. The method for producing a perovskite-type oxyhydride according to claim 8, wherein RE is Y or Sc.

11. The method for producing a perovskite-type oxyhydride according to claim 8, wherein RE is Y.

12. The method for producing a perovskite-type oxyhydride according to claim 8, wherein a planetary ball mill or a tumbling ball mill is used in the mechanochemical method.

13. The method for producing a perovskite-type oxyhydride according to claim 8, wherein the crimping and the pulverization are carried out at a temperature of 300 °C or less.

14. The method for producing a perovskite-type oxyhydride according to claim 8, wherein the specific surface area (BET) of the refined and homogeneous particles of a synthesis reaction product is 5.0 m²/g or less.

15. (canceled)

16. (canceled)
